(19) United States
(12) Patent Application Publication
(10) Pub. No.: US 2026/0230229 A1
(43) Pub. Date: Aug. 6, 2026

(54) CHANNEL OCCUPANCY TIME INTERRUPTION AVOIDANCE

(71) Applicant: Nokia Technologies Oy, Espoo (FI)

(72) Inventors: Laura Luque SANCHEZ, Aalborg (DK); Renato Barbosa ABREU, Aalborg (DK); Nuno Manuel KIILERICH PRATAS, Aalborg (DK); Thomas Haaning JACOBSEN, Aalborg (DK); Jian Guo LIU, Shanghai (CN); Timo Erkki LUNTTILA, Espoo (FI); Yong LIU, Shanghai (CN); Akshay JAISWAL, Bangalore (IN); Naizheng ZHENG, Beijing (CN)

(21) Appl. No.: 19/151,675

(22) PCT Filed: Feb. 17, 2023
(86) PCT No.: PCT/CN2023/077004

§ 371 Date: Jul. 29, 2025

(51) Int. Cl. H04L 1/08; H04W 72/0446

(52) U.S. Cl. CPC H04L 1/08; H04W 72/0446

(57) ABSTRACT

Embodiments of the present disclosure relate to COT interruption avoidance. An apparatus determines that a first sidelink transport block (TB) among a plurality of sidelink TBs is not to be retransmitted. A set of consecutive slots in a channel occupancy time (COT) initiated by the apparatus are reserved for initial sidelink transmissions and retransmissions of the plurality of sidelink TBs. Moreover, the apparatus transmits a second sidelink TB in a slot among the set of consecutive slots reserved for retransmitting the first sidelink TB. As a result, it is possible to avoid additional system overhead due to COT loss, and improve transmission efficiency.

### FIELD

Various example embodiments relate to the field of telecommunication and in particular, to methods, devices, apparatuses, and computer readable storage media for channel occupancy time (COT) interruption avoidance.

### BACKGROUND

In telecommunications networks, such as Long Term Evolution (LTE) networks or Next Generation 5G networks, sidelink communications between user equipment (UEs) over a proximity services (ProSe) Communication 5 (PC5) wireless interface may be supported. In sidelink communications, UEs may communicate with each other directly via a PC5 wireless interface on a sidelink channel. Further, sidelink communications may obtain a plurality of benefits, such as coverage extension, service reliability enhancement, and potential low latency.

Especially, unlicensed technologies may need to abide to the conformance requirement of regulations such as a listen-before-talk (LBT) regulation so as to ensure existence fairness with other UEs in the shared unlicensed spectrum. In an LBT procedure, prior to transmission, the transmitting (Tx) UE performs LBT operation in a contention window (CW), and the UE can obtain the “right” to access the channel for a certain period of time—denoted in the regulations as the COT, only if the channel is detected to be free for the entire duration of the CW. The Tx UE performs a sidelink transmission during the COT, and then the Tx UE is aware of a reception status at the receiving UE (Rx) UE based on hybrid automatic repeat request (HARQ) feedback to determine the need for a sidelink retransmission. However, there are still some open problems for the sidelink transmission during the COT that will be studied in the near future.

### SUMMARY

In general, example embodiments of the present disclosure provide a solution related to COT interruption avoidance.

In a first aspect, there is provided an apparatus. The apparatus comprises at least one processor and at least one memory storing instructions that, when executed by the at least one processor, cause the apparatus at least to: determine that a first sidelink transport block, TB, among a plurality of sidelink TBs is not to be retransmitted, wherein a set of consecutive slots in a channel occupancy time, COT, initiated by the apparatus are reserved for initial sidelink transmissions and retransmissions of the plurality of sidelink TBs; and transmit a second sidelink TB in a slot among the set of consecutive slots reserved for retransmitting the first sidelink TB.

In a second aspect, there is provided an apparatus. The apparatus comprises at least one processor and at least one memory storing instructions that, when executed by the at least one processor, cause the apparatus at least to: determine that a first sidelink transport block, TB, among a plurality of sidelink TBs from another apparatus is received successfully, wherein a set of consecutive slots in a channel occupancy time, COT, initiated by the another apparatus are reserved for initial sidelink transmissions and retransmissions of the plurality of sidelink TBs; and receive, from the another apparatus, a second sidelink TB in a slot among the set of consecutive slots reserved for retransmitting the first sidelink TB.

In a third aspect, there is provided an apparatus. The apparatus comprises at least one processor and at least one memory storing instructions that, when executed by the at least one processor, cause the apparatus at least to: determine that a first sidelink transport block, TB, among a plurality of sidelink TBs from another apparatus is not to be retransmitted, wherein a set of consecutive slots in a channel occupancy time, COT, initiated by the another apparatus are reserved for initial sidelink transmissions and retransmissions of the plurality of sidelink TBs; and transmit a sidelink transmission in a slot among the set of consecutive slots reserved for retransmitting the first sidelink TB.

In a fourth aspect, there is provided a method. The method comprises determining, at an apparatus, that a first sidelink transport block, TB, among a plurality of sidelink TBs is not to be retransmitted, wherein a set of consecutive slots in a channel occupancy time, COT, initiated by the apparatus are reserved for initial sidelink transmissions and retransmissions of the plurality of sidelink TBs; and transmitting a second sidelink TB in a slot among the set of consecutive slots reserved for retransmitting the first sidelink TB.

In a fifth aspect, there is provided a method. The method comprises determining, at an apparatus, that a first sidelink transport block, TB, among a plurality of sidelink TBs from another apparatus is received successfully, wherein a set of consecutive slots in a channel occupancy time, COT, initiated by the another apparatus are reserved for initial sidelink transmissions and retransmissions of the plurality of sidelink TBs; and receiving, from the another apparatus, a second sidelink TB in a slot among the set of consecutive slots reserved for retransmitting the first sidelink TB.

In a sixth aspect, there is provided a method. The method comprises determining, at an apparatus, that a first sidelink transport block, TB, among a plurality of sidelink TBs from another apparatus is not to be retransmitted, wherein a set of consecutive slots in a channel occupancy time, COT, initiated by the another apparatus are reserved for initial sidelink transmissions and retransmissions of the plurality of sidelink TBs; and transmitting a sidelink transmission in a slot among the set of consecutive slots reserved for retransmitting the first sidelink TB.

In a seventh aspect, there is provided an apparatus. The apparatus comprises means for determining, at an apparatus, that a first sidelink transport block, TB, among a plurality of sidelink TBs is not to be retransmitted, wherein a set of consecutive slots in a channel occupancy time, COT, initiated by the apparatus are reserved for initial sidelink transmissions and retransmissions of the plurality of sidelink TBs; and transmitting a second sidelink TB in a slot among the set of consecutive slots reserved for retransmitting the first sidelink TB.

In an eighth aspect, there is provided an apparatus. The apparatus comprises means for determining that a first sidelink transport block, TB, among a plurality of sidelink TBs from another apparatus is received successfully, wherein a set of consecutive slots in a channel occupancy time, COT, initiated by the another apparatus are reserved for initial sidelink transmissions and retransmissions of the plurality of sidelink TBs; and means for receiving, from the another apparatus, a second sidelink TB in a slot among the set of consecutive slots reserved for retransmitting the first sidelink TB.

In a ninth aspect, there is provided an apparatus. The apparatus comprises means for determining that a first sidelink transport block, TB, among a plurality of sidelink TBs from another apparatus is not to be retransmitted, wherein a set of consecutive slots in a channel occupancy time, COT, initiated by the another apparatus are reserved for initial sidelink transmissions and retransmissions of the plurality of sidelink TBs; and means for transmitting a sidelink transmission in a slot among the set of consecutive slots reserved for retransmitting the first sidelink TB.

In a tenth aspect, there is provided a non-transitory computer readable medium comprising program instructions for causing an apparatus to perform at least the method according to any one of the above fourth to sixth aspects.

In an eleventh aspect, there is provided a computer program comprising instructions, which, when executed by an apparatus, cause the apparatus at least to perform at least the method according to any one of the above fourth to sixth aspects.

In a twelfth aspect, there is provided an apparatus. The apparatus is a terminal device, comprising determining circuitry configured to determine that a first sidelink transport block, TB, among a plurality of sidelink TBs is not to be retransmitted, wherein a set of consecutive slots in a channel occupancy time, COT, initiated by the apparatus are reserved for initial sidelink transmissions and retransmissions of the plurality of sidelink TBs; and transmitting circuitry configured to transmit a second sidelink TB in a slot among the set of consecutive slots reserved for retransmitting the first sidelink TB.

In a thirteenth aspect, there is provided an apparatus. The apparatus is a terminal device, comprising determining circuitry configured to determine that a first sidelink transport block, TB, among a plurality of sidelink TBs from another apparatus is received successfully, wherein a set of consecutive slots in a channel occupancy time, COT, initiated by the another apparatus are reserved for initial sidelink transmissions and retransmissions of the plurality of sidelink TBs; and receiving circuitry configured to receive, from the another apparatus, a second sidelink TB in a slot among the set of consecutive slots reserved for retransmitting the first sidelink TB.

In a fourteenth aspect, there is provided an apparatus. The apparatus is a terminal device, comprising determining circuitry configured to determine that a first sidelink transport block, TB, among a plurality of sidelink TBs from another apparatus is not to be retransmitted, wherein a set of consecutive slots in a channel occupancy time, COT, initiated by the another apparatus are reserved for initial sidelink transmissions and retransmissions of the plurality of sidelink TBs; and transmitting circuitry configured to transmit a sidelink transmission in a slot among the set of consecutive slots reserved for retransmitting the first sidelink TB.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example environment in which example embodiments of the present disclosure can be implemented;

FIG. 1B shows an example sidelink slot format with physical sidelink control channel (PSCCH)/physical sidelink shared channel (PSSCH) associated with some example embodiments of the present disclosure;

FIG. 1C shows an example sidelink slot format with PSCCH/PSSCH and physical sidelink feedback channel (PSFCH) associated with some example embodiments of the present disclosure;

FIG. 1D shows an example diagram for New radio (NR) sidelink resource allocation mode 1 associated with some example embodiments of the present disclosure;

FIG. 1E shows an example diagram for NR sidelink resource allocation mode 2 associated with some example embodiments of the present disclosure;

FIG. 1F shows an example resource allocation scheme for sidelink resource allocation mode 2 associated with some example embodiments of the present disclosure;

FIG. 1G shows an example procedure to determine the resource candidate set associated with some example embodiments of the present disclosure;

FIG. 1H shows an example clear channel assessment (CCA) slot associated with some example embodiments of the present disclosure;

FIG. 1I shows an example diagram of the acquisition of the COT associated with some example embodiments of the present disclosure;

FIG. 1J shows an example LBT type 1 contention window countdown procedure associated with some example embodiments of the present disclosure;

FIG. 1K shows an example of the allowed gaps for LBT type 2 associated with some example embodiments of the present disclosure;

FIG. 1L shows an example diagram of when a responding device has to acquire a new COT associated with some example embodiments of the present disclosure;

FIG. 2 illustrates a signaling flow between apparatuses according to some example embodiments of the present disclosure;

FIG. 3A illustrates an example sidelink transmission with a reordering approach according to some example embodiments of the present disclosure;

FIG. 3B illustrates an example sidelink transmission with a new transmission approach according to some example embodiments of the present disclosure;

FIG. 3C illustrates an example sidelink transmission with a blind retransmission approach according to some example embodiments of the present disclosure;

FIG. 3D illustrates an example sidelink transmission with a sharing COT approach according to some example embodiments of the present disclosure;

FIG. 4 illustrates a flowchart of a method implemented at an apparatus according to some embodiments of the present disclosure;

FIG. 5 illustrates a flowchart of another method implemented at an apparatus according to some embodiments of the present disclosure;

FIG. 6 illustrates a flowchart of a further method implemented at an apparatus according to some embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned systems.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a New Radio (NR) NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

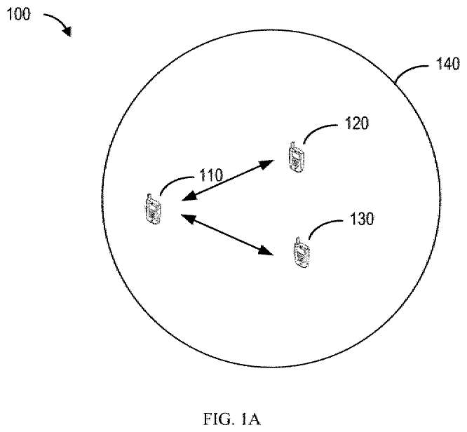

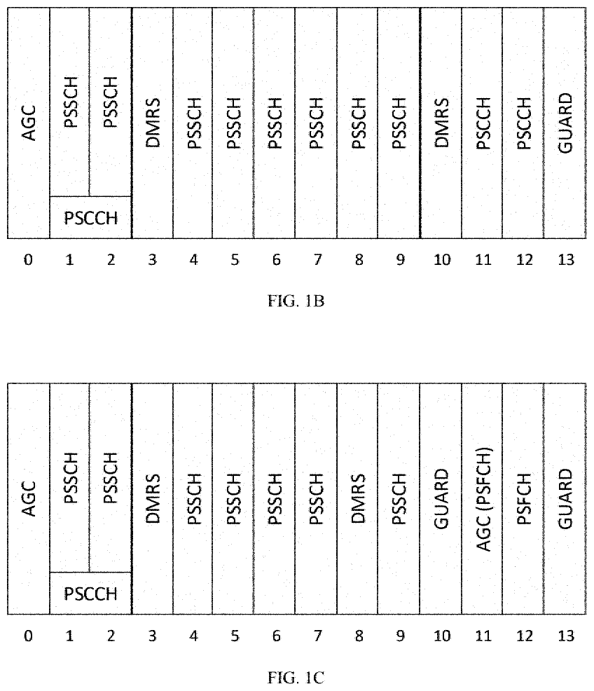

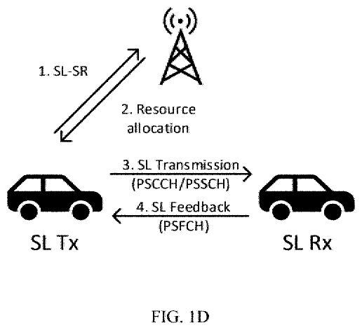

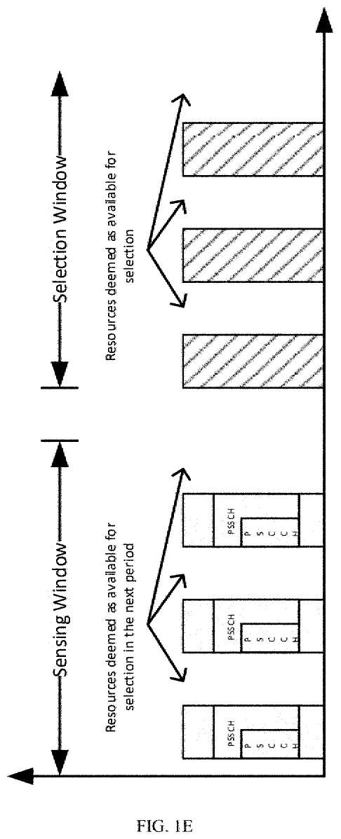

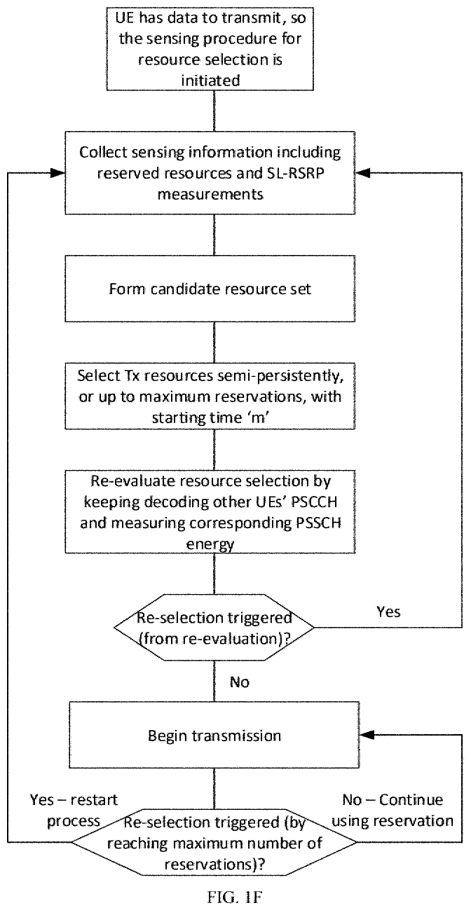

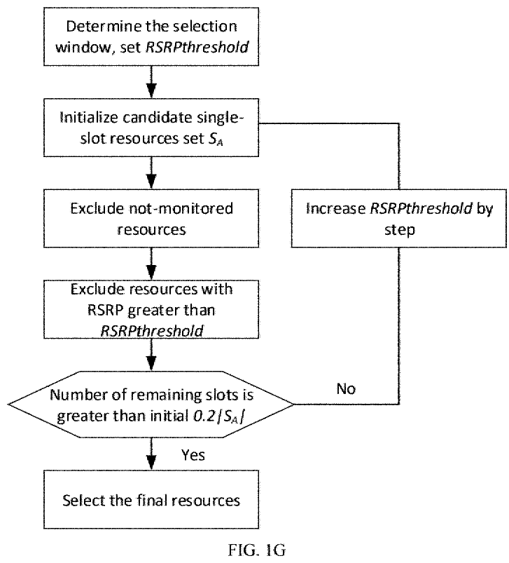

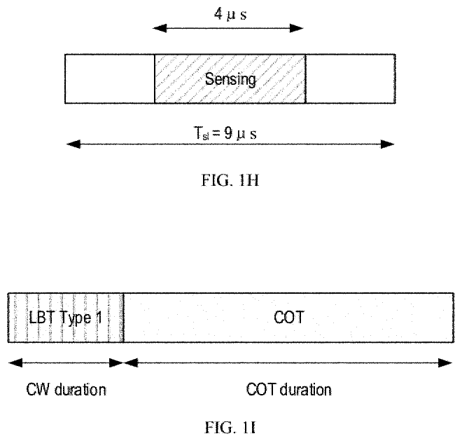

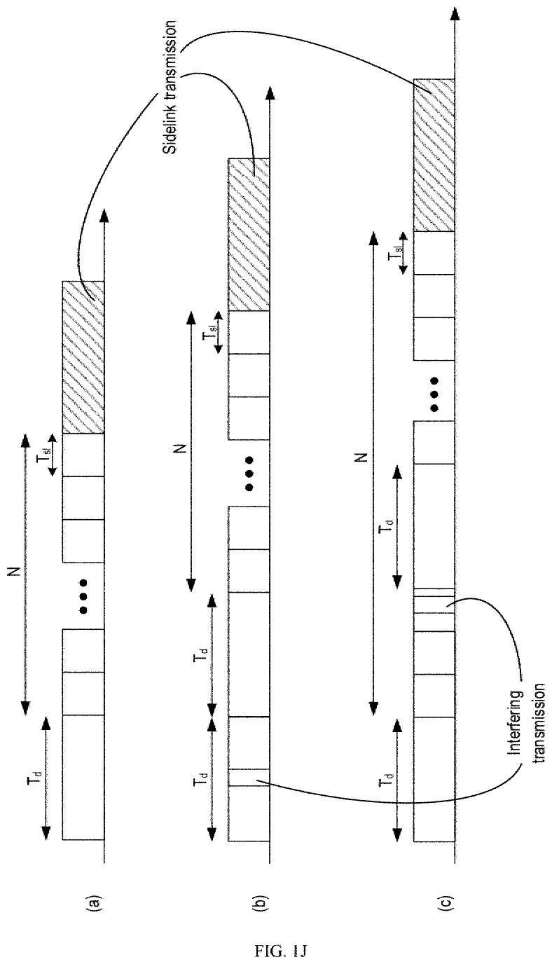

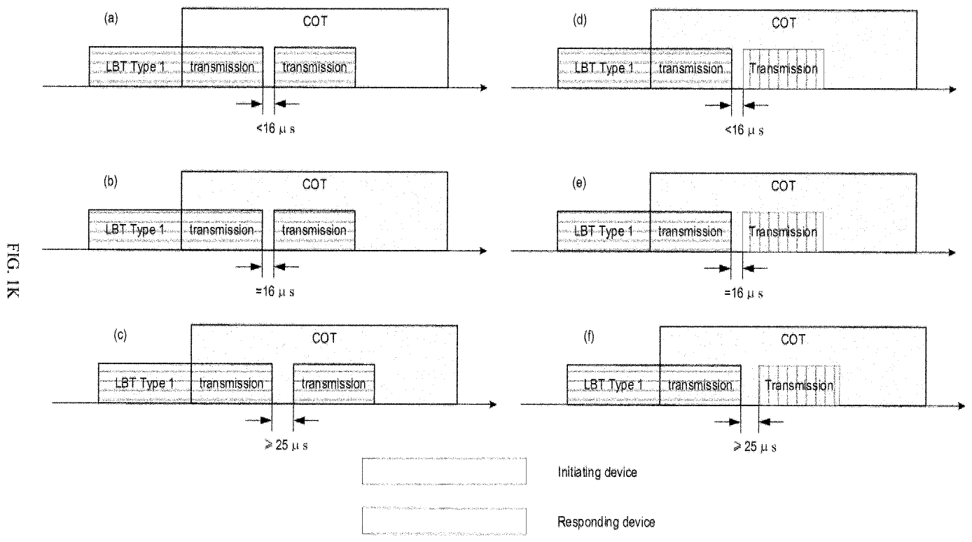

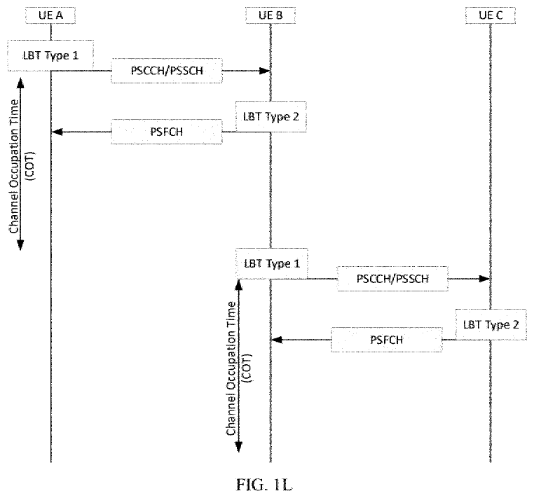

Principles and embodiments of the present disclosure will be described in detail below with reference to the accompanying drawings. Reference is first made to FIG. 1A, which illustrates an example environment 100 in which example embodiments of the present disclosure can be implemented.

The environment 100, which may be a part of a communication network, comprises apparatuses 110, 120, and 130 in a system 140. As an example, the apparatus 110 may communicate with one or both of the apparatuses 120 and 130 or with other apparatuses via apparatus 120 or the apparatus 130.

The apparatuses 110, 120, and 130 may be implemented by any suitable apparatuses in the communication network. In some example embodiments, some of the apparatuses 110, 120, and 130 may be implemented by one or more terminal devices and the others may be implemented by one or more network devices, or vice versa. In some other example embodiments, the apparatuses 110, 120, and 130 may be all implemented by terminal devices or network devices.

According to some embodiments of the present disclosure, in the environment 100, the system 140 may be a sidelink system and the apparatuses 110, 120, and 130 can perform sidelink communications. In these embodiments, the apparatuses 110, 120, and 130 may be implemented by terminal devices. Just for the purpose of discussion, in some example embodiments, the apparatus 110 will be taken as an example of a Tx device that initiates sidelink transmission. The apparatus 120 will be taken as an example of an Rx device of the sidelink transmission. The apparatus 130 will be taken as an example of a third device.

In some example embodiments, the apparatus 120 may be taken as an example of an Rx device of the sidelink transmission, and the apparatus 130 may be taken as an example of a device with which a COT initiated by the apparatus 110 is shared. In this case, the apparatus 120 may use the COT shared by apparatus 110 for its own transmission.

In some other examples, the apparatus 130 may not be present, and then the apparatus 120 may be called the apparatus 130. In this case, the apparatus 120 may use the COT shared by apparatus 110 for its own transmission.

It is to be understood that three apparatuses are shown in the environment 100 only for the purpose of illustration, without suggesting any limitation to the scope of the present disclosure. In some example embodiments, the environment 100 may comprise one or more further apparatuses to communicate with the apparatus 110.

The communications in the environment 100 may follow any suitable communication standards or protocols, which are already in existence or to be developed in the future, such as Universal Mobile Telecommunications System (UMTS), long term evolution (LTE), LTE-advanced (LTE-A), the fifth generation (5G) new radio (NR), wireless fidelity (Wi-Fi) and worldwide interoperability for microwave access (WiMAX) standards, and employs any suitable communication technologies, including, for example, multiple-input multiple-output (MIMO), orthogonal frequency division multiplexing (OFDM), time division multiplexing (TDM), frequency division multiplexing (FDM), code division multiplexing (CDM), bluetooth, ZigBee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

In legacy sidelink, with contiguous resource block (RB)-based transmission, in the frequency domain a resource pool (RP) consists of a set of consecutive subchannels, where a subchannel consists of a number of consecutive RBs. The total number of RBs within a given RP can be configured with a value from 10 to 275. Generally, the sidelink resource allocation, sensing, and resource selection operations are based on the subchannel. According to technical specification (TS) 38.331, the size of the subchannel is configurable and can take the values 10, 12, 15, 20, 25, 50, 75, and 100 RBs, and there can be from 1 to 27 configured numbers of subchannels in a given RP.

For PSCCH transmission, it is always associated with the lowest subchannel of scheduled PSSCH, meaning that, the bandwidth size (in terms of the number of RBs) of PSCCH is always smaller or equal to the size of one subchannel. The configuration of the PSCCH (e.g., a demodulation reference signal (DMRS), a modulation and coding scheme (MCS), the number of symbols used) is also part of the resource pool configuration. The PSCCH occupies sl-FreqResourcePSCCH (10,12,15,20, or 25, ≤, subchannel size) PRBs over sl-TimeResourcePSCCH (2 or 3) OFDM symbols which are (pre) configured by resource pool signaling, e.g. by a radio resource control (RRC) signaling according to TS 38.331.

Examples of the sidelink slot structure are depicted in FIG. 1B and FIG. 1C, where FIG. 1B shows an example sidelink slot format with PSCCH/PSSCH associated with some example embodiments of the present disclosure and FIG. 1C shows an example sidelink slot format with PSCCH/PSSCH and PSFCH associated with some example embodiments of the present disclosure. As shown in FIG. 1C, a last symbol is used for the PSFCH. The location of the PSCCH is in the lowest part of the allocated subchannel(s).

During the third generation partnership project (3GPP) release 16 (Rel-16), NR sidelink has been designed to facilitate a UE to communicate with other nearby UE(s) via direct/sidelink communication. Two resource allocation modes have been specified, and a sidelink Tx UE is configured with one of them to perform its NR sidelink transmissions. These modes are denoted as NR sidelink mode 1 and NR sidelink mode 2. FIG. 1D and FIG. 1E shows example diagrams for NR sidelink resource allocation modes 1 and 2 associated with some example embodiments of the present disclosure respectively. In mode 1, a sidelink transmission resource is assigned (scheduled) by the network to the sidelink Tx UE, while a sidelink Tx UE in mode 2 autonomously selects its sidelink transmission resources.

As shown in FIG. 1D, in mode 1, at step 1, the Tx UE transmits a sidelink scheduling request (SR) to the gNB. At step 2, the gNB transmits the sidelink resource allocation to the Tx UE. At step 3, the Tx UE transmits sidelink transmission to the Rx UE based on the allocated resources. At step 4, the Rx UE transmits sidelink feedback for the sidelink transmission to the Tx UE.

As shown in FIG. 1E, in mode 2, the sidelink UEs perform autonomously the resource selection with the aid of a sensing procedure. More specifically, a sidelink Tx UE in NR sidelink mode 2 first performs a sensing procedure over the configured sidelink transmission resource pool(s), to obtain the knowledge of the reserved resource(s) by other nearby sidelink Tx UE(s). Based on the knowledge obtained from sensing, the sidelink Tx UE may select a resource from the available sidelink resources, accordingly. For a sidelink UE to perform sensing and obtain the necessary information to receive a sidelink transmission, it needs to decode the sidelink control information (SCI). In Rel-16, the SCI associated with a data transmission includes a 1st-stage SCI and a 2nd-stage SCI, and their contents are standardized in 3GPP TS 38.212.

In mode 2 sidelink, each UE autonomously selects resources by decoding the PSCCH (or SCI) and performing reference signal received power (RSRP) measurement of (pre-)configured resource pool(s) based on a procedure, for example, specified in 3GPP 38.214 on a candidate resource pool during a sensing window interval.

The SCI follows a 2-stage SCI structure, whose main motivation is to support the size difference between the SCIs for various NR-V2X sidelink service types (e.g., broadcast, groupcast and unicast).

The 1st-stage SCI, SCI format 1-A, is carried by PSCCH and contains:
information to enable sensing operations
information needed to determine resource allocation of the PSSCH and to decode 2nd-stage SCI

As per Rel-16, the contents of the 1st-stage SCI are the following:

```
From TS 38.212:
8.3.1.1 SCI format 1-A
SCI format 1-A is used for the scheduling of PSSCH and 2^{nd}-stage-SCI on PSSCH
The following information is transmitted by means of the SCI format 1-A:
  - Priority — 3 bits as defined in clause 5.4.3.3 of [12, TS 23.287].
  -  $Frequency resource assignment - ⌈ {log}_{2} ( \frac{{N}_{subChannel}^{SL} ( {N}_{subChannel}^{SL} + 1 )}{2} ) ⌉ bits when the value of the$
    higher layer parameter sl-MaxNumPerReserve is configured to 2; otherwise
      $⌈ {log}_{2} ( \frac{{N}_{s u b C h a nnel}^{S L} ( {N}_{s u b C h a nnel}^{S L} + 1 ) ( 2 {N}_{s u b C hannel}^{S L} + 1 )}{6} ) ⌉$
    bits when the value of the higher layer parameter sl-MaxNumPerReserve is configured to 3, as
    defined in clause 8.1.2.2 of [6, TS 38.214].
  - Time resource assignment — 5 bits when the value of the higher layer parameter
    sl-MaxNumPerReserve is configured to 2; otherwise 9 bits when the value of the higher layer
    parameter sl-MaxNumPerReserve is configured to 3, as defined in clause 8.1.2.1 of [6, TS
    38.214].
  - Resource reservation period — ┌log₂ Nᵣₛᵥ_period┐ bits as defined in clause 8.1.4 of [6, TS
    38.214], where Nᵣₛᵥ_period is the number of entries in the higher layer parameter
    sl-ResourceReservePeriodList, if higher layer parameter sl-MultiReserveResource is
    configured; 0 bit otherwise.
  - DMRS pattern — ┌log₂ Nₚₐₜₜₑᵣₙ┐ bits as defined in clause 8.4.1.1.2 of [4, TS 38.211], where
    Nₚₐₜₜₑᵣₙ is the number of DMRS patterns configured by higher layer parameter
    sl-PSSCH-DMRS-TimePatternList; 0 bit if sl-PSSCH-DMRS-TimePatternList is not
    configured.
  - 2^{nd}-stage SCI format — 2 bits as defined in Table 8.3.1.1-1.
  - Beta offset indicator — 2 bits as provided by higher layer parameter sl-BetaOffsets2ndSCI and
    Table 8.3.1.1-2.
  - Number of DMRS port — 1 bit as defined in Table 8.3.1.1-3.
  - Modulation and coding scheme — 5 bits as defined in clause 8.1.3 of [6, TS 38.214].
  - Additional MCS table indicator — as defined in clause 8.1.3.1 of [6, TS 38.214]: 1 bit if one
    MCS table is configured by higher layer parameter sl-Additional-MCS-Table; 2 bits if two
    MCS tables are configured by higher layer parameter sl-Additional-MCS-Table; 0 bit
    otherwise.
  - PSFCH overhead indication — 1 bit as defined clause 8.1.3.2 of [6, TS 38.214] if higher layer
    parameter sl-PSFCH-Period = 2 or 4; 0 bit otherwise.
  - Reserved — a number of bits as determined by higher layer parameter sl-NumReservedBits, with
    value set to zero.
Table 8.3.1.1-1: 2^{nd}-stage SCI formats
```

| Value of 2nd-stage SCI | |
|---|---|
| format field | 2nd-stage SCI format |
| 00 | SCI format 2-A |
| 01 | SCI format 2-B |
| 10 | Reserved |
| 11 | Reserved |

The 2nd-stage SCI (for example, SCI format 2-A and 2-B) is carried by PSSCH (multiplexed with PSSCH) and contains:
Source and destination identities
information to identify and decode the associated PSSCH TB
control of HARQ feedback in unicast/groupcast
trigger for CSI feedback in unicast

As per Rel-16, the contents of the 2nd-stage SCI are provided in Table 1:

TABLE 1
2nd-stage SCI formats

| SCI Format 2-A | SCI Format 2-B |
|---|---|
| HARQ process number - 4 bits. | HARQ process number - 4 bits. |
| New data indicator - 1 bit. | New data indicator - 1 bit. |
| Redundancy version - 2 bits as defined in | Redundancy version - 2 bits as defined in |
| Table 7.3.1.1.1-2. | Table 7.3.1.1.1-2. |
| Source ID - 8 bits as defined in clause 8.1 | Source ID - 8 bits as defined in clause 8.1 |
| of [6, TS 38.214]. | of [6, TS 38.214]. |
| Destination ID - 16 bits as defined in | Destination ID - 16 bits as defined in clause |
| clause 8.1 of [6, TS 38.214]. | 8.1 of [6, TS 38.214]. |
| HARQ feedback enabled/disabled | HARQ feedback enabled/disabled indicator - |
| indicator - 1 bit as defined in clause 16.3 | 1 bit as defined in clause 16.3 of [5, TS |
| of [5, TS 38.213]. | 38.213]. |
| Cast type indicator - 2 bits as defined in | Zone ID - 12 bits as defined in clause |
| Table 8.4.1.1-1 and in clause 8.1 of [6, TS | 5.8.11 of [9, TS 38.331]. |
| 38.214]. | Communication range requirement - 4 bits |
| CSI request - 1 bit as defined in clause | determined by higher layer parameter |
| 8.2.1 of [6, TS 38.214] and in clause 8.1 | sl-ZoneConfigMCR-Index. |
| of [6, TS 38.214]. | |

FIG. 1F shows an example resource allocation scheme for sidelink resource allocation mode 2 associated with some example embodiments of the present disclosure. The monitoring of the resource pool and acquisition of information to be used during the resource selection procedure can be done prior to the Tx UE knowing that it has a transmission to perform. Then, as shown in FIG. 1F, as the Tx UE has data to transmit, the sensing procedure for resource selection is initiated. Further, the Tx UE collects sensing information, and after the Tx UE has acquired enough information from its monitoring of the resource pool it can form the candidate resource set.

Then, the Tx UE selects Tx resources semi-persistently or up to maximum reservations with starting time ‘m’. the Tx UE re-evaluates resource selection by keeping decoding other UE's PSCCH and measuring corresponding PSSCH energy. Then, the Tx UE determines whether a re-selection is triggered or not. If the re-selection is not triggered, the Tx UE begins transmission. Otherwise, a fallback is made to the collection of the sensing information. Moreover, a further determination of whether a re-selection is triggered or not is made.

FIG. 1G shows an example procedure to determine the resource candidate set associated with some example embodiments of the present disclosure. Resources within a candidate resource pool have been monitored during a sensing window interval. During this sensing window interval, the UE collects the set of S_{A} of potential candidate resource slots that are within a defined selection window period and exclude all resources/slots which
The UE has not monitored them during the sensing period (e.g. due to own transmission or other activities including DRX);
The decoded SCI format 1-A indicates that the candidate slot is reserved and the corresponding measured RSRP is above a pre-configured RSRPthreshold.

If the number of remaining single slot candidates is greater than X|S_{A}| (where X=0.2, 0.35, 0.5), the UE forwards the potential candidate slots to the higher for final resource selection. Otherwise, it increases the RSRPthreshold by a step (i.e. RSRPthreshold=RSRPthreshold+step, where the step per the TS 38.214 is currently defined to be 3 dB) and repeats the procedure. Final candidate slots are then forwarded to higher layers for the final resource selection.

FIG. 1H shows an example CCA slot associated with some example embodiments of the present disclosure. As shown in FIG. 1H, the duration Tₛₗ is 9 us, and the energy sensing takes place during 4 us.

In sub-7 GHz unlicensed bands, the NR coexistence with other systems (e.g. institute of electrical and electronics engineers (IEEE) 802.11) is ensured via an LBT channel access mechanism. With the mechanism, a Tx UE intending to perform a sidelink transmission needs first to successfully complete an LBT check, before being able to initiate that same transmission. LBT can also be referred to as a clear channel assessment (CCA) or channel access procedure.

For a Tx UE to pass an LBT check, it must observe the channel as available for a number of consecutive CCA slots. In sub-7 GHz, the duration of these slots is 9 μs, as depicted in FIG. 1H. The Tx UE deems the channel as available in a CCA slot if the measured power (i.e. the collected energy during the CCA slot) is below a regulatory specified threshold (which may depend on the operating band and geographical region).

FIG. 1I shows an example diagram of the acquisition of the COT associated with some example embodiments of the present disclosure. When a UE initiates the communication (i.e. the UE takes the role of initiating device), then this UE has to acquire the “right” to access the channel for a COT by applying an LBT procedure (for example, an “extended” LBT procedure) where the channel must be deemed as free for the entire duration of a CW. This “extended” LBT procedure, is commonly known as LBT Type 1 as specified in TS 37.213.

The duration of both the COT and the CW depends on the channel access priority class (CAPC) associated with the UE's traffic, as shown in the following Table 2. Control plane traffic (such as PSCCH) is transmitted with p=1, while user plane traffic has p>1. In Table 2, we depict the LBT Type 1 details for the Uu uplink (UL) case, but we note that the downlink (DL) case LBT Type 1 parameters could also in principle be adopted in sidelink.

TABLE 2
CAPC for uplink

| Channel | | | | | |
|---|---|---|---|---|---|
| Access | | | | | |
| Priority | | | | | allowed CWₚ |
| Class (p) | mₚ | CW_{min, p} | CW_{max, p} | T_{ulmcot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 us. The maximum duration before including any such gap shall be 6 ms.

As shown in Table 2, the contention window length in CCA slots associated with each CAPC has a minimum (CW_{min,p}) and maximum (CW_{max,p}). The duration of the COT is given by T_{ulm cot, p}.

FIG. 1J shows an example LBT type 1 contention window countdown procedure associated with some example embodiments of the present disclosure, where T_{d} refers to the defer time, Tₛₗ refers to the CCA slot duration and N refers to the number of CCA slots required to be deemed as free before the contention window countdown is complete. If during the countdown procedure, the LBT check fails in any CCA slot, then the countdown will stop and will only resume if the channel is deemed as free (i.e. the LBT check is successful) during a defer time.

Examples of how the contention window countdown procedure can be disrupted are shown in FIG. 1J, where example (a) shows the case when neither the defer time nor the contention window count down are disrupted (i.e. the channel is not detected as busy during a sensing slot), example (b) shows the case when the defer time is disrupted (i.e. the channel is detected as busy during a defer time sensing slot), and example (c) shows the case when the contention window count down is disrupted (i.e. the channel is detected as busy during a sensing slot of the countdown).

The UE initiating the transmission (also referred to as the initiating device) upon successfully completing the LBT Type 1 and performing a transmission, acquires the COT with duration associated with the corresponding CAPC. The acquired COT is valid even in the case where the initiating device pauses its transmission, although if the initiating device wants to perform a new transmission (within the COT) it is still required to perform a “reduced” LBT procedure. This “reduced” LBT procedure, is commonly known as LBT Type 2 (for example, see TS 37.213).

FIG. 1K shows an example diagram of the allowed gaps for LBT type 2 associated with some example embodiments of the present disclosure. Where the LBT Type 2 has the following variants:
Type 2A (25 μs LBT)—for sidelink transmissions within the initiating device acquired COT (in case the gap between two sidelink transmissions is ≥25 μs, as well for sidelink transmissions following another sidelink transmission), as shown in (c) and (f) in FIG. 1K;
Type 2B (16 μs LBT)—for sidelink transmission within the initiating device acquired COT (can only be used for sidelink transmissions following another sidelink with a gap exactly equal to 16 μs), as shown in (b) and (e) in FIG. 1K;
Type 2C (no LBT)—can only be used for sidelink transmission following another sidelink, with a gap ≤16 μs and the allowed duration of the sidelink transmission ≤584 μs), as shown in (a) and (d) in FIG. 1K.

As shown in FIG. 1K, (a), (b). and (c) show the cases where the gap is between the two transmissions both from the initiating UE, while (d), (e), and (f) show the cases where the gap is between the two different transmissions from the initiating UE and the responding UE correspondingly.

The initiating device can share its acquired COT with its intended receiver (the responding device). For this purpose, the initiating device shall inform (e.g. via control signaling) the responding device about the duration of this COT. The responding device uses then this information to decide which type of LBT it should apply upon performing a transmission for which the intended receiver is the initiating device. In case the responding device transmission falls outside the COT, then the responding device will have to acquire a new COT using the LBT Type 1 with the appropriate CAPC.

FIG. 1L shows an example diagram of when a responding device has to acquire a new COT associated with some example embodiments of the present disclosure. As shown in FIG. 1L, as the UE B determines that its transmission falls outside the COT initiated by the UE A, it needs to acquire a new COT for the sidelink transmission to the UE C.

In the recent radio access network workgroup 1 (RAN1) #94e meeting, the release 18 (Rel-18) work item (RP-213678) on sidelink enhancements was approved with the following objectives related to sidelink unlicensed (SL-U):

2. Study and specify support of sidelink on unlicensed spectrum for both mode 1 and mode 2
where Uu operation for mode 1 is limited to licensed spectrum only [RAN1, RAN2, RAN4]

| - | Channel access mechanisms from NR-U shall be reused for sidelink unlicensed | |
|---|---|---|
| | operation | |
| | ∘ | Assess the applicability of sidelink resource reservation from Rel-16/Rel-17 to |

| sidelink unlicensed operation within the boundaries of unlicensed channel | |
|---|---|
| access mechanism and operation | |
| ▪ | No specific enhancements for Rel-17 resource allocation mechanisms |
| ▪ | If the existing NR-U channel access framework does not support the |

required SL-U functionality, WGs will make appropriate
recommendations for RAN approval.

| - | Physical channel design framework: Required changes to NR sidelink physical | |
|---|---|---|
| | channel structures and procedures to operate on unlicensed spectrum | |
| | ∘ | The existing NR sidelink and NR-U channel structure shall be reused as the |

baseline.

| | |
|---|---|
| - | No specific enhancements for existing NR SL feature |
| - | The study should focus on FR1 unlicensed bands (n46 and n96/n102) and is to be |
| | completed by RAN#98. |

Moreover, in meeting RAN1 #110-e, the 3GPP has agreed the following:

Agreement

Multi-consecutive slots transmission (MCSt) is supported for Mode 1 and Mode 2 resource

allocation in SL-U.

| | |
|---|---|
| • | FFS details |

In meeting RAN1 #1 10-bis-e, the following agreement has been made:

Agreement
On the support of MCSt operation in SL-U, the following options are to be further studied and one
or more of the following options will be selected in future meetings.

| • | When L1 is triggered for reporting a subset of candidate resources for MCSt, | |
|---|---|---|
| | ∘ | Option 1: Only one set of parameters (prio_{TX}, remaining PDB, L_{subCH} and Pᵣₛᵥₚ_{_{—}}_{TX}) is |

| provided for the resource selection procedure in L1 | |
|---|---|
| ▪ | Note, this is applicable for transmission of a single TB and multiple TBs |
| ▪ | FFS: whether this is the same or different than Rel-16 |

| | ∘ | Option 2: one or multiple sets of parameters (prio_{TX}, remaining PDB, L_{subCH} and |
|---|---|---|
| | | Pᵣₛᵥₚ_{_{—}}_{TX}) are provided for the resource selection procedure in L1 |
| | ∘ | FFS: any further information needs to be provided to L1 for MCSt |
| • | When L1 reports a subset of candidate resources for MCSt, | |
| | ∘ | Option A: L1 reports candidate multi-slot resources in S_{A} where a candidate multi-slot |

| resource consists of a set of single-slot resources that are consecutive in time | |
|---|---|
| ▪ | FFS whether the set of single-slot resources within a candidate multi-slot |

resource can have different L_{subCH} sizes

| | |
|---|---|
| ∘ | Option B: L1 reports candidate single-slot resources in (S_{A}) as in Rel-16 |

| | |
|---|---|
| ▪ | It is up to the higher (MAC) layer to select a set of single-slot resources that |

are consecutive in logical slots

| | |
|---|---|
| ∘ | Option C: L1 reports consecutive single-slot candidate resources in S_{A} |

| | |
|---|---|
| ▪ | FFS whether the consecutive single-slot candidate resources can have different |

L_{subCH} sizes

| | |
|---|---|
| ∘ | FFS: any further information needs to be reported to MAC layer, provided to L1 or |

utilized for MCSt

FFS: whether/how to consider the additional LBT time in SL resource allocation

In meeting RAN1 #110-bis, it has been agreed on the support of MCSt and the details on how it should be defined and used are under discussion. Some of these discussions are related to whether the transmission over the consecutive slots would be for a single UE or different UEs, what is the maximum number of consecutive slots, or whether the Guard Period (GP) between those consecutive slots can be used for PSSCH transmission.

In the case of MCSt during N consecutive slots with HARQ feedback configured by the Tx UE, such UE may reserve N resources for the initial transmission as well as other N resources for the retransmission of all TBs in case of negative HARQ feedback. The Tx UE expects to receive acknowledgment (ACK)/non-acknowledgment (NACK) feedback for each of the TBs transmitted in the consecutive slots. If the feedback is negative (NACK), the Tx UE may use the reserved resources to proceed with the retransmissions, while if the feedback is positive (ACK), the retransmissions are not needed. However, it may occur that some of the TBs are NACK'ed and some other TBs are ACK'ed, which means that only some of the reserved slots for retransmissions may be used.

In such a case, the Tx UE may proceed with retransmissions in some slots and stop the transmission during one or more slots, corresponding to the TBs that have been ACK'ed. During the gap in which the Tx UE is not transmitting, some other UEs (which are not using the COT shared by the Tx UE) or UEs from other RATs, i.e. WiFi, may perform successful LBT type 1 and acquire the COT, causing the initial Tx UE to lose its COT and not being able to finish the required retransmissions or even continue later with its normal transmission until the end of the ongoing COT.

Therefore, as of now, there does not seem to exist an effective way to allow the Tx UE using MCSt with HARQ feedback to perform retransmissions without losing the COT and without forcing the Tx UE to retransmit TBs that have been ACK'ed.

According to embodiments of the present disclosure, there is provided a scheme for COT interruption avoidance. With this scheme, an apparatus determines that a first sidelink transport block (TB) among a plurality of sidelink TBs is not to be retransmitted. A set of consecutive slots in COT initiated by the apparatus are reserved for initial sidelink transmissions and retransmissions of the plurality of sidelink TBs. Moreover, the apparatus transmits a second sidelink TB in a slot among the set of consecutive slots reserved for retransmitting the first sidelink TB.

This scheme allows COT interruption avoidance, for example, in the MCTs, by avoiding the slot gap left by the TB not to be retransmitted. In this way, it is possible to avoid additional system overhead due to COT loss, and improve transmission efficiency.

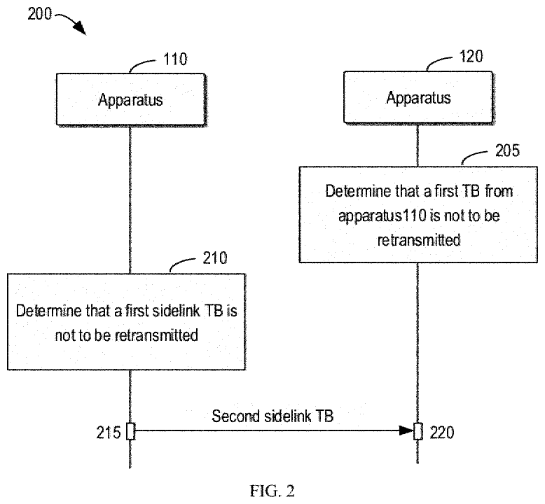

FIG. 2 illustrates a signaling flow 200 between apparatuses according to some example embodiments of the present disclosure. For the purpose of discussion, the signaling flow 200 will be described with reference to FIG. 1A.

As shown in FIG. 2, the apparatus 120 determines (205) that a first sidelink TB among a plurality of sidelink TBs from the apparatus 110 is received successfully. For example, for MCSt cases, a set of consecutive slots in a COT initiated by the apparatus 110 may be reserved for initial sidelink transmissions and retransmissions of the plurality of sidelink TBs. The apparatus 120 may transmit the ACK feedback for the first sidelink TB to the apparatus 110. Then, the apparatus 110 determines (205) that the first sidelink TB among the plurality of sidelink TBs is not to be retransmitted.

In some example embodiments, in order to avoid the COT loss, the apparatus 110 may fill the empty slot (also referred to as, gap) left by the first sidelink TB with a second sidelink TB. As shown in FIG. 2, the apparatus 110 transmits (215) the second sidelink TB in a slot among the set of consecutive slots reserved for retransmitting the first sidelink TB. Accordingly, the second apparatus 120 receives (220), from the apparatus 110, the second sidelink TB in the slot among the set of consecutive slots reserved for retransmitting the first sidelink TB.

Likewise, the apparatus 110 may fill one or more other empty slots left by one or more other sidelink TBs that have been ACK'ed (i.e. with ACK feedback) with one or more further sidelink TBs. On this basis, COT loss may be avoided and thus the apparatus 110 may finish one or more retransmissions of one or more sidelink TBs, among the plurality of sidelink TBs, that have been NACK'ed (i.e. with NACK feedback) and keep the acquired COT for as long as the COT duration dictates.

Taking filling the gap left by the first sidelink TB with the second sidelink TB as an example, the gap left by the first sidelink TB may be filled in a variety of ways.

### Reordering Approach

In some example embodiments, the apparatus 110 may reorder the one or more retransmissions of one or more sidelink TBs, among the plurality of sidelink TBs, that have been NACK'ed, so that a sidelink TB (i.e. the second sidelink TB) that has to be retransmitted later in the same MCSt as the first sidelink TB may be moved to the gap left by the first sidelink TB. That is, a retransmission of the second sidelink TB may be adjusted to the slot left by the first sidelink TB.

For example, in case several sidelink TBs including the first sidelink TB are correctly received (ACK'ed) and therefore several slots reserved for the retransmissions of the ACK'ed TBs may be left empty, the reordering may be done in the following way. The first empty slot (for example, the slot reserved for retransmitting the first sidelink TB) may be filled with the retransmission of the last sidelink TB of the MCSt that has been NACK'ed. The second empty slot may be filled with the retransmission of the second last sidelink TB of the MCSt that has been NACK'ed. Then, the reordering may be continued until all the empty slots have been filled or all the retransmissions after the empty slots have been reordered. The above reordering may allow performing all the needed retransmissions in the minimum time possible, leaving the empty slot(s) at the end of the MCSt to be utilized for other purposes.

As an example, the empty slot(s) caused by the reordering may be used for new traffic. For example, in case there is only one sidelink TB (for example, the first sidelink TB) not to be retransmitted and only one sidelink TB (for example, the second sidelink TB) to be retransmitted, as the retransmission of the second sidelink TB has been moved to the slot left by the first sidelink TB, the slot reserved for retransmitting the second sidelink TB may be free. Then, the slot reserved for retransmitting the second sidelink TB may be used to transmit a third sidelink TB (for example, new data) in a further sidelink transmission other than the initial sidelink transmissions (for example, the following new transmission, such as new traffic from the next burst). That is, in this case, the retransmission of the second sidelink TB using the empty slot reserved for retransmitting the first sidelink TB may occur first, followed by an initial transmission of the third sidelink TB using the empty slot reserved for retransmitting the second sidelink TB to fill the remainder of the MCSt burst caused by adjusting the retransmission of the second sidelink TB to the empty slot left by the first sidelink TB.

The apparatus 110 may share the COT with a terminal device, or allow acquisition of the COT by a terminal device, such that the empty slot(s) caused by the reordering may be usable by the terminal device. In other words, the empty slot(s) caused by the reordering may be used by other apparatuses (including, for example, apparatus 120) with which the COT is shared, or other apparatuses (including, for example, apparatus 130) that acquire the COT.

In some example embodiments, the apparatus 110 may transmit an indication of an empty slot (for example, caused by the reordering of one or more retransmissions of one or more sidelink TB to be retransmitted) among the set of consecutive slots from which the apparatus 110 is to stop sidelink transmissions. In this case, information about the empty slot(s) (e.g. from which the apparatus 110 will stop transmissions) may be indicated by the apparatus 110 in SCIs in transmissions in the previous slot(s), so that other apparatus may better prepare in advance.

The advantage of this approach is, beyond the avoidance of COT interruption, that the apparatus can finish one or more retransmissions earlier and can continue with its normal operation (for example, sending new traffic, or allowing other apparatuses that are using the shared COT to transmit). If the last one or more slots (or several last slots in case several sidelink TBs are ACK'ed and more than one sidelink TB to be retransmitted is reordered and transmitted in empty slots left by the several sidelink TBs) are unused, the apparatus 110 may give the chance to another SL-U apparatus, or a further apparatus from a different radio access technology (RAT) like wireless fidelity (WiFi) to perform an LBT operation and, if successful, acquire the COT.

In some example embodiments, the apparatus 110 may transmit, for example, in an SCI, information about a TB index in each slot with a sidelink transmission among the set of consecutive slots. The apparatus 110 may indicate the information on TB index (for example, HARQ process identifier) in each slot (of the MCSt retransmission) with sidelink transmission in SCI(s) in the first slot or other slots. This will facilitate physical layer combining at an Rx apparatus, for example, the apparatus 120.

In some example embodiments, in the case of the sidelink TBs requiring a different number of sub-channels and in the presence of reservations from other apparatuses, the reordering may be constrained by the available number of sub-channels. For example, there may be a first number of sub-channels (for example, 2 sub-channels) reserved for the first sidelink TB, there is a reservation by another apparatus in the neighbour sub-channels and a second number of sub-channels (for example, 4 sub-channels) is required by the second sidelink TB. In that case, the resources reserved for the first sidelink TB may not fit the second sidelink TB. Then, to facilitate the retransmission of the second sidelink TB, the apparatus 110 may adjust a TB size. Changing the TB size may require media access control (MAC) layer involvement to discard and re-encode a smaller segment. As another example, to facilitate the retransmission of the second sidelink TB, the apparatus 110 may adjust an MCS. Changing the MCS may require a re-encoding. As a further example, to facilitate the retransmission of the second sidelink TB, the apparatus 110 may adjust the number of sub-channels reserved for the first sidelink TB to fit the number of sub-channels required by the second sidelink TB. Expanding the original reservation of the first sidelink TB to fit the second sidelink TB may be an appropriate approach, unless there may be no way to increase the allocation without causing a collision with another apparatus's reservation.

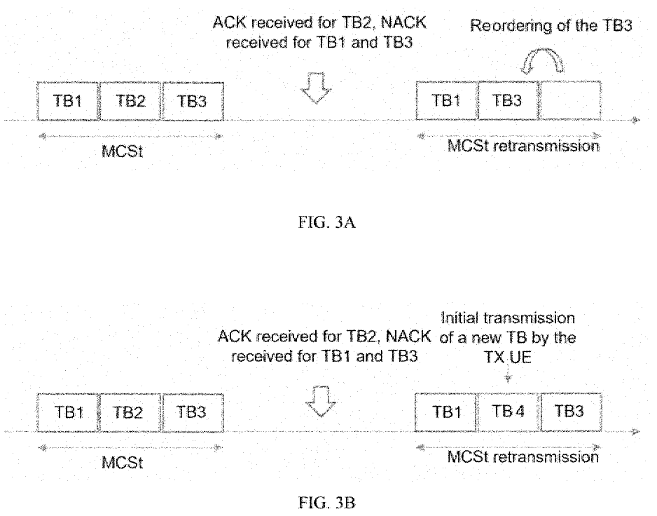

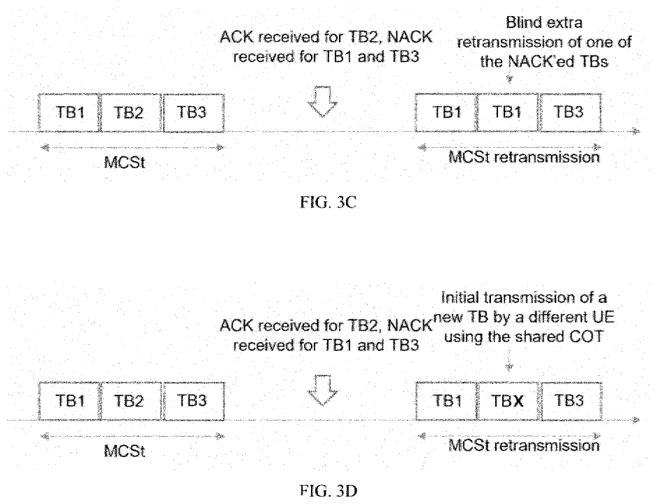

FIG. 3A illustrates an example sidelink transmission with the reordering approach according to some example embodiments of the present disclosure. As shown in FIG. 3A, ACK feedback has been received for TB2, and NACK feedback has been received for TB1 and TB3. The retransmission of TB3 is reordered to the empty slot reserved for retransmitting the TB2.

### New Transmission Approach

In some example embodiments, the apparatus 110 may fill the gap left by the first sidelink TB with a sidelink TB of the following transmission, for example, a new transmission for traffic from the next burst. In this case, the second sidelink TB may comprise a sidelink TB to be transmitted in a further sidelink transmission (that is, a new initial transmission) other than the initial sidelink transmissions of the plurality of sidelink TBs.

This approach may be applied when the apparatus 110 has more data to be transmitted, so the apparatus 110 may be able to fill the empty slot with a new transmission that, otherwise, would have to be performed later. In this way, the traffic may be transmitted sooner and the COT may not be interrupted.

FIG. 3B illustrates an example sidelink transmission with the new transmission approach according to some example embodiments of the present disclosure. As shown in FIG. 3B, ACK feedback has been received for TB2, and NACK feedback has been received for TB1 and TB3. The empty slot reserved for retransmitting the TB2 is used to transmit a new TB (i.e., TB4) which was in the buffer.

### Blind Retransmission Approach

In some example embodiments, the apparatus 110 may fill the gap left by the first sidelink TB with a blind extra retransmission of a sidelink TB to be retransmitted (i.e. sidelink TB that has been NACK'ed). In this case, the second sidelink TB is a sidelink TB to be retransmitted among the plurality of sidelink TBs.

For example, the apparatus 110 may select the sidelink TB to be retransmitted among the plurality of sidelink TBs based on an estimated failure probability of the retransmission of the sidelink TB. For example, the selection of the sidelink TB to be retransmitted in the gap left by the first sidelink TB may be based on an estimated probability of TB failure, for example, based on history using machine learning. Alternatively or additionally, the apparatus 110 may just simply randomly choose the sidelink TB to be retransmitted in the gap.

In other words, in this case, the selected sidelink TB (i.e., the second sidelink TB) may be retransmitted twice, once in the empty slot left by the first sidelink TB, and once in the slot reserved for retransmitting the second sidelink TB.

FIG. 3C illustrates an example sidelink transmission with the blind retransmission approach according to some example embodiments of the present disclosure. As shown in FIG. 3C, ACK feedback has been received for TB2, and NACK feedback has been received for TB1 and TB3. In addition to the retransmission in the slot reserved for retransmitting the TB1, a new retransmission of the TB1 is performed in the empty slot reserved for retransmitting the TB2.

### Sharing COT Approach

In the example embodiments where the COT initiated by the apparatus 110 is shared with further one or more apparatuses (for example, including the apparatus 120 and/or the apparatus 130), if transmissions from the one or more apparatus are allowed in the MCSt, the one or more apparatus may use such free slot reserved for the retransmission of the first sidelink TB for their own sidelink transmissions.

This approach is feasible without further communication from the apparatus 100 to the one or more apparatuses with which the COT is shared, since those apparatuses may be also monitoring the HARQ feedback for the plurality of sidelink TBs transmitted by the apparatus 110, and know in advance when a slot will be free.

As there is a possibility that, even though the one or more apparatuses receive ACK feedback for example, for the first sidelink TB, the apparatus 110 may not receive the ACK feedback due to bad radio conditions. Therefore, the one or more apparatuses may not make sure the slot reserved for retransmitting the first sidelink TB is free. Thus additionally, the apparatus 110 may indicate that the slot reserved for retransmitting the first sidelink TB is a free slot, for example, by transmitting an indication to the one or more apparatuses. For example, the apparatus 110 may include the information on one or more empty slots (including the empty slot reserved for retransmitting the first sidelink TB) in SCI(s) (e.g. in the first slot with sidelink transmission or in every slot with a sidelink transmission from the apparatus 110) to let the one or more apparatuses know the information on available free slots.

In some example embodiments, in order to avoid simultaneous transmissions from the further one or more apparatuses in the empty slot left by the first sidelink TB, an option may be to limit the use of the empty slot to the Rx apparatus (i.e., the apparatus 120) associated with the ACK'ed sidelink transmission(s). The advantage is that it can be used even when the apparatus 110 does not have any remaining data to be transmitted.

FIG. 3D illustrates an example sidelink transmission with the sharing COT approach according to some example embodiments of the present disclosure. In this case, a UE initiating the COT shares the COT with another UE. As shown in FIG. 3A, ACK feedback has been received for TB2, and NACK feedback has been received for TB1 and TB3. The empty slot reserved for retransmitting the TB2 is used by the another UE using the shared COT for an initial transmission of a new TB (i.e., TBx).

In the examples discussed with reference to FIGS. 3A to 3D, it's assumed the UE initiates a channel occupancy at the first slot (TB1), i.e. it passes an LBT procedure before the first slot of MCSt retransmission. However, if the UE does not finish the LBT procedure before the first slot of the MCSt for retransmission (i.e. it initiates the COT at the 2nd, 3rd, . . . , slot), the proposed approaches can still be applied similarly.

### Dummy Information Approach

In some example embodiments, the apparatus 110 may fill the gap left by the first sidelink TB with dummy information.

In some example embodiments, one or more of the apparatuses 110, 120, and 130 may be terminal devices. Alternatively or additionally, one or more of the apparatuses 110, 120, and 130 may be implemented by any other types of devices or apparatus.

In this way, such proposed approaches solve the problem of COT interruption due to positive HARQ feedback of one or more of the sidelink TBs in an MCSt without forcing the apparatus 110 to retransmit the already ACK'ed sidelink TB(s).

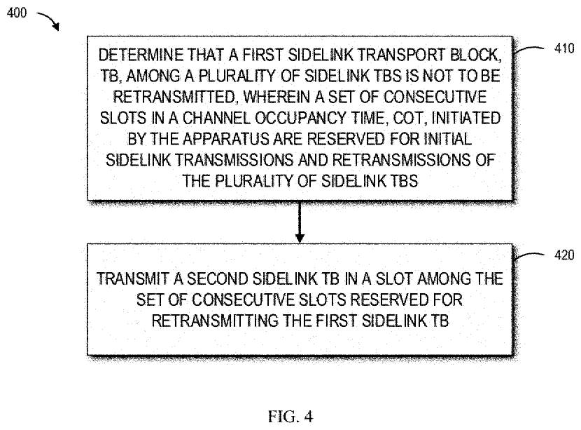

FIG. 4 illustrates a flowchart of a method implemented at an apparatus according to some embodiments of the present disclosure. For the purpose of discussion, the method 400 will be described from the perspective of the apparatus 110 with reference to FIG. 1A.

At block 410, the apparatus 110 determines that a first sidelink transport block, TB, among a plurality of sidelink TBs is not to be retransmitted. A set of consecutive slots in a channel occupancy time, COT, initiated by the apparatus 110 are reserved for initial sidelink transmissions and retransmissions of the plurality of sidelink TBs. At block 420, the apparatus 110 transmits a second sidelink TB in a slot among the set of consecutive slots reserved for retransmitting the first sidelink TB.

In some example embodiments, to transmit the second sidelink TB, the apparatus 110 may reorder at least one retransmission of at least one sidelink TB to be retransmitted of the plurality of sidelink TBs, the at least one TB comprising the second sidelink TB, and adjusts, to the slot, a retransmission of the second sidelink TB. In some example embodiments, the apparatus 110 may further transmit, in a slot reserved for retransmitting the second sidelink TB, a third sidelink TB to be transmitted in a further sidelink transmission other than the initial sidelink transmissions. In some example embodiments, the apparatus 110 may further transmit an indication of an empty slot among the set of consecutive slots from which the apparatus 110 is to stop sidelink transmissions, the empty slot being caused by the reordering of at least one retransmission of at least one sidelink TB. In some example embodiments, the apparatus 110 may further share the COT with a terminal device, or allow acquisition of the COT by a terminal device, such that the empty slot is usable by said terminal device.

In some example embodiments, the number of sub-channels required by the second sidelink TB may be greater than the number of sub-channels reserved for the first sidelink TB, and to transmit the second sidelink TB, the apparatus 110 may further adjust a TB size, adjust a modulation and coding scheme, MCS, adjust the number of sub-channels reserved for the first sidelink TB to fit the number of sub-channels required by the second sidelink TB, or any combination of the above-listed items.

In some example embodiments, the apparatus 110 may further transmit, in sidelink control information, SCI, information about a TB index in each slot with a sidelink transmission among the set of consecutive slots. In some example embodiments, the second sidelink TB may comprise a sidelink TB to be transmitted in a further sidelink transmission other than the initial sidelink transmissions.

In some example embodiments, the second sidelink TB may comprise a sidelink TB to be retransmitted among the plurality of sidelink TBs, and the apparatus 110 may further retransmit the second sidelink TB in a slot among the set of consecutive slots reserved for retransmitting the second sidelink TB. In some example embodiments, the apparatus 110 may further select the second sidelink TB based on an estimated failure probability of the retransmission of the second sidelink TB. In some example embodiments, the apparatus 110 may be a terminal device.

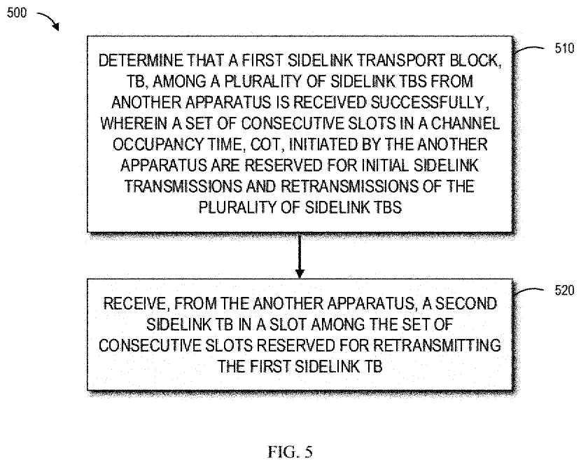

FIG. 5 illustrates a flowchart of another method implemented at an apparatus according to some embodiments of the present disclosure. For the purpose of discussion, the method 500 will be described from the perspective of the apparatus 120 with reference to FIG. 1A.

At block 510, the apparatus 120 determines that a first sidelink transport block, TB, among a plurality of sidelink TBs from apparatus 110 is received successfully. A set of consecutive slots in a channel occupancy time, COT, initiated by the apparatus 110 are reserved for initial sidelink transmissions and retransmissions of the plurality of sidelink TBs. At block 520, the apparatus 120 receives, from the apparatus 110, a second sidelink TB in a slot among the set of consecutive slots reserved for retransmitting the first sidelink TB.

In some example embodiments, the second sidelink TB may comprise a sidelink TB to be retransmitted among the plurality of sidelink TBs, and retransmissions of at least one sidelink TB to be retransmitted of the plurality of sidelink TBs may be reordered by the apparatus 110, the at least one TB comprising the second sidelink TB, and a retransmission of the second sidelink TB may be adjusted by the apparatus 110 to the slot. In some example embodiments, the apparatus 120 may further receive, from the apparatus 110, in a slot reserved for retransmitting the second sidelink TB, a third sidelink TB to be transmitted in a further sidelink transmission other than the initial sidelink transmissions.

In some example embodiments, the apparatus 120 may further receive, from the apparatus 110, an indication of an empty slot among the set of consecutive slots from which the apparatus 110 is to stop sidelink transmissions, the empty slot being caused by the reordering of retransmissions of at least one sidelink TB. In some example embodiments, the COT may be usable by a terminal device with which the COT is shared, or a terminal device allowed to acquire the COT. In some example embodiments, the apparatus 120 may further receive, from the apparatus 110, in sidelink control information, SCI, information about a TB index in each slot with a sidelink transmission among the set of consecutive slots.

In some example embodiments, the second sidelink TB may comprise a sidelink TB to be transmitted in a further sidelink transmission other than the initial sidelink transmission. In some example embodiments, the second sidelink TB may comprise a sidelink TB to be retransmitted among the plurality of sidelink TBs, and the apparatus 120 may further receive, from the apparatus 110, the second sidelink TB in a slot among the set of consecutive slots reserved for retransmitting the second sidelink TB. In some example embodiments, the apparatus 120 may be a terminal device.

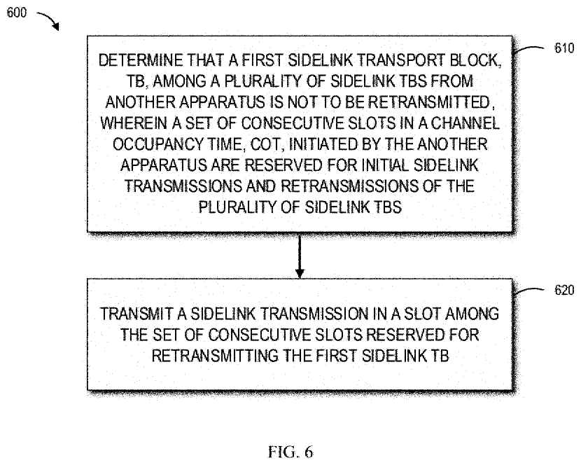

FIG. 6 illustrates a flowchart of a further method implemented at an apparatus according to some embodiments of the present disclosure. For the purpose of discussion, the method 600 will be described from the perspective of the apparatus 130 with reference to FIG. 1A.

At block 610, the apparatus 130 determines that a first sidelink transport block, TB, among a plurality of sidelink TBs from the apparatus 110 is not to be retransmitted. A set of consecutive slots in a channel occupancy time, COT, initiated by the apparatus 110 are reserved for initial sidelink transmissions and retransmissions of the plurality of sidelink TBs. At block 620, the apparatus 130 transmits a sidelink transmission in a slot among the set of consecutive slots reserved for retransmitting the first sidelink TB.

In some example embodiments, the apparatus 130 may further receive, from the apparatus 110, an indication that the slot is a free slot. In some example embodiments, the apparatus 130 may be a terminal device.

In some example embodiments, an apparatus capable of performing the method 400 (for example, the apparatus 110) may comprise means for performing the respective steps of the method 400. The means may be implemented in any suitable form. For example, the means may be implemented in a circuitry or software module.

In some example embodiments, the apparatus comprises means for determining that a first sidelink transport block, TB, among a plurality of sidelink TBs is not to be retransmitted, wherein a set of consecutive slots in a channel occupancy time, COT, initiated by the apparatus are reserved for initial sidelink transmissions and retransmissions of the plurality of sidelink TBs; and means for transmitting a second sidelink TB in a slot among the set of consecutive slots reserved for retransmitting the first sidelink TB.

In some example embodiments, the means for transmitting the second sidelink TB comprises means for reordering at least one retransmission of at least one sidelink TB to be retransmitted of the plurality of sidelink TBs, the at least one TB comprising the second sidelink TB; and means for adjusting, to the slot, a retransmission of the second sidelink TB. In some example embodiments, the apparatus further comprises means for transmitting, in a slot reserved for retransmitting the second sidelink TB, a third sidelink TB to be transmitted in a further sidelink transmission other than the initial sidelink transmissions.

In some example embodiments, the apparatus further comprises means for transmitting an indication of an empty slot among the set of consecutive slots from which the apparatus is to stop sidelink transmissions, the empty slot being caused by the reordering of at least one retransmission of at least one sidelink TB. In some example embodiments, the apparatus further comprises means for sharing the COT with a terminal device, or allowing acquisition of the COT by a terminal device, such that the empty slot is usable by said terminal device.

In some example embodiments, the number of sub-channels required by the second sidelink TB is greater than the number of sub-channels reserved for the first sidelink TB, and the apparatus may further comprise means for performing at least one of the following for transmitting the second sidelink TB: adjusting a TB size; adjusting a modulation and coding scheme, MCS; or adjusting the number of sub-channels reserved for the first sidelink TB to fit the number of sub-channels required by the second sidelink TB. In some example embodiments, the apparatus further comprises means for transmitting, in sidelink control information, SCI, information about a TB index in each slot with a sidelink transmission among the set of consecutive slots.

In some example embodiments, the second sidelink TB comprises a sidelink TB to be transmitted in a further sidelink transmission other than the initial sidelink transmissions. In some example embodiments, the second sidelink TB comprises a sidelink TB to be retransmitted among the plurality of sidelink TBs, and the apparatus may further comprise means for retransmitting the second sidelink TB in a slot among the set of consecutive slots reserved for retransmitting the second sidelink TB. In some example embodiments, the apparatus may further comprise means for selecting the second sidelink TB based on an estimated failure probability of the retransmission of the second sidelink TB.

In some example embodiments, the apparatus is a terminal device.

In some example embodiments, the apparatus further comprises means for performing other steps in some embodiments of the method 400. In some embodiments, the means comprises at least one processor and at least one memory including computer program code. The at least one memory and computer program code are configured to, with the at least one processor, cause the performance of the apparatus.

In some example embodiments, an apparatus capable of performing the method 500 (for example, the apparatus 120) may comprise means for performing the respective steps of the method 500. The means may be implemented in any suitable form. For example, the means may be implemented in a circuitry or software module.

In some example embodiments, the apparatus comprises means for determining that a first sidelink transport block, TB, among a plurality of sidelink TBs from another apparatus is received successfully, wherein a set of consecutive slots in a channel occupancy time, COT, initiated by the another apparatus are reserved for initial sidelink transmissions and retransmissions of the plurality of sidelink TBs; and means for receiving, from the another apparatus, a second sidelink TB in a slot among the set of consecutive slots reserved for retransmitting the first sidelink TB.

In some example embodiments, the second sidelink TB comprises a sidelink TB to be retransmitted among the plurality of sidelink TBs, and retransmissions of at least one sidelink TB to be retransmitted of the plurality of sidelink TBs are reordered by the another apparatus, the at least one TB comprising the second sidelink TB, and a retransmission of the second sidelink TB is adjusted by the another apparatus to the slot. In some example embodiments, the apparatus may further comprise means for receiving, from the another apparatus, in a slot reserved for retransmitting the second sidelink TB, a third sidelink TB to be transmitted in a further sidelink transmission other than the initial sidelink transmissions.

In some example embodiments, the apparatus may further comprise means for receiving, from the another apparatus, an indication of an empty slot among the set of consecutive slots from which the another apparatus is to stop sidelink transmissions, the empty slot being caused by the reordering of retransmissions of at least one sidelink TB. In some example embodiments, the COT is usable by a terminal device with which the COT is shared, or a terminal device allowed to acquire the COT. In some example embodiments, the apparatus may be further configured to comprise means for receiving, from the another apparatus, in sidelink control information, SCI, information about a TB index in each slot with a sidelink transmission among the set of consecutive slots.

In some example embodiments, the second sidelink TB comprises a sidelink TB to be transmitted in a further sidelink transmission other than the initial sidelink transmission. In some example embodiments, the second sidelink TB comprises a sidelink TB to be retransmitted among the plurality of sidelink TBs, and the apparatus further comprises means for receiving, from the another apparatus, the second sidelink TB in a slot among the set of consecutive slots reserved for retransmitting the second sidelink TB. In some example embodiments, the apparatus is a terminal device.

In some example embodiments, the apparatus further comprises means for performing other steps in some embodiments of the method 500. In some embodiments, the means comprises at least one processor and at least one memory including computer program code. The at least one memory and computer program code are configured to, with the at least one processor, cause the performance of the apparatus.

In some example embodiments, an apparatus capable of performing the method 600 (for example, the apparatus 130) may comprise means for performing the respective steps of the method 600. The means may be implemented in any suitable form. For example, the means may be implemented in a circuitry or software module.

In some example embodiments, the apparatus comprises means for determining that a first sidelink transport block, TB, among a plurality of sidelink TBs from another apparatus is not to be retransmitted, wherein a set of consecutive slots in a channel occupancy time, COT, initiated by the another apparatus are reserved for initial sidelink transmissions and retransmissions of the plurality of sidelink TBs; and means for transmitting a sidelink transmission in a slot among the set of consecutive slots reserved for retransmitting the first sidelink TB.

In some example embodiments, the apparatus may further comprise means for receiving, from the another apparatus, an indication that the slot is a free slot. In some example embodiments, the apparatus is a terminal device.

In some example embodiments, the apparatus further comprises means for performing other steps in some embodiments of the method 600. In some embodiments, the means comprises at least one processor and at least one memory including computer program code. The at least one memory and computer program code are configured to, with the at least one processor, cause the performance of the apparatus.

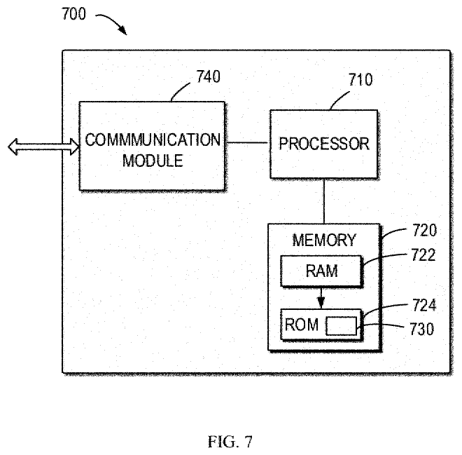

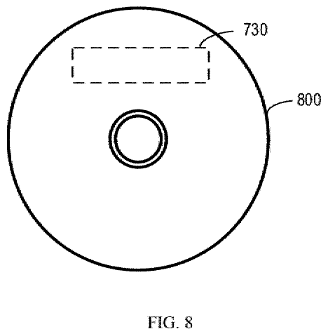

FIG. 7 illustrates a simplified block diagram of a device 700 that is suitable for implementing some example embodiments of the present disclosure. The device 700 may be provided to implement the communication device, for example, the apparatus 110, the apparatus 130 or apparatus 130 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 3D. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 4 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-28. (canceled)

29. An apparatus comprising:
at least one processor; and
at least one memory storing instructions that, when executed by the at least one processor, cause the apparatus at least to:
determine that a first sidelink transport block, TB, among a plurality of sidelink TBs is not to be retransmitted, wherein a set of consecutive slots in a channel occupancy time, COT, initiated by the apparatus are reserved for initial sidelink transmissions and retransmissions of the plurality of sidelink TBs; and
transmit a second sidelink TB in a slot among the set of consecutive slots reserved for retransmitting the first sidelink TB.

30. The apparatus of claim 29, wherein the apparatus is configured to transmit the second sidelink TB by:
reordering at least one retransmission of at least one sidelink TB to be retransmitted of the plurality of sidelink TBs, the at least one TB comprising the second sidelink TB; and
adjusting, to the slot, a retransmission of the second sidelink TB.

31. The apparatus of claim 30, wherein the apparatus is further configured to:
transmit, in a slot reserved for retransmitting the second sidelink TB, a third sidelink TB to be transmitted in a further sidelink transmission other than the initial sidelink transmissions.

32. The apparatus of claim 30, wherein the apparatus is further configured to:
transmit an indication of an empty slot among the set of consecutive slots from which the apparatus is to stop sidelink transmissions, the empty slot being caused by the reordering of at least one retransmission of at least one sidelink TB.

33. The apparatus of claim 32, wherein the apparatus is further configured to:
share the COT with a terminal device, or allow acquisition of the COT by a terminal device, such that the empty slot is usable by said terminal device.

34. The apparatus of claim 30, wherein the number of sub-channels required by the second sidelink TB is greater than the number of sub-channels reserved for the first sidelink TB, and wherein the apparatus is further configured to perform at least one of the following for transmitting the second sidelink TB:
adjusting a TB size;
adjusting a modulation and coding scheme, MCS; or
adjusting the number of sub-channels reserved for the first sidelink TB to fit the number of sub-channels required by the second sidelink TB.

35. The apparatus of claim 30, wherein the apparatus is further configured to:
transmit, in sidelink control information, SCI, information about a TB index in each slot with a sidelink transmission among the set of consecutive slots.

36. The apparatus of claim 29, wherein the second sidelink TB comprises a sidelink TB to be transmitted in a further sidelink transmission other than the initial sidelink transmissions.

37. The apparatus of claim 29, wherein the second sidelink TB comprises a sidelink TB to be retransmitted among the plurality of sidelink TBs, and wherein the apparatus is further configured to:
retransmit the second sidelink TB in a slot among the set of consecutive slots reserved for retransmitting the second sidelink TB.

38. The apparatus of claim 37, wherein the apparatus is further configured to:
select the second sidelink TB based on an estimated failure probability of the retransmission of the second sidelink TB.

39. The apparatus of claim 29, wherein the apparatus is a terminal device.

40. An apparatus comprising:
at least one processor; and
at least one memory storing instructions that, when executed by the at least one processor, cause the apparatus at least to:
determine that a first sidelink transport block, TB, among a plurality of sidelink TBs from another apparatus is received successfully, wherein a set of consecutive slots in a channel occupancy time, COT, initiated by the another apparatus are reserved for initial sidelink transmissions and retransmissions of the plurality of sidelink TBs; and
receive, from the another apparatus, a second sidelink TB in a slot among the set of consecutive slots reserved for retransmitting the first sidelink TB.

41. The apparatus of claim 40, wherein the second sidelink TB comprises a sidelink TB to be retransmitted among the plurality of sidelink TBs, and wherein retransmissions of at least one sidelink TB to be retransmitted of the plurality of sidelink TBs are reordered by the another apparatus, the at least one TB comprising the second sidelink TB, and a retransmission of the second sidelink TB is adjusted by the another apparatus to the slot.

42. The apparatus of claim 41, wherein the apparatus is further configured to:
receive, from the another apparatus, in a slot reserved for retransmitting the second sidelink TB, a third sidelink TB to be transmitted in a further sidelink transmission other than the initial sidelink transmissions.

43. The apparatus of claim 41, wherein the apparatus is further configured to:
receive, from the another apparatus, an indication of an empty slot among the set of consecutive slots from which the another apparatus is to stop sidelink transmissions, the empty slot being caused by the reordering of retransmissions of at least one sidelink TB.

44. The apparatus of claim 40, wherein the second sidelink TB comprises a sidelink TB to be transmitted in a further sidelink transmission other than the initial sidelink transmission.

45. The apparatus of claim 40, wherein the second sidelink TB comprises a sidelink TB to be retransmitted among the plurality of sidelink TBs, and wherein the apparatus is further configured to:
receive, from the another apparatus, the second sidelink TB in a slot among the set of consecutive slots reserved for retransmitting the second sidelink TB.

46. The apparatus of claim 40, wherein the apparatus is a terminal device.

47. An apparatus, comprising:
at least one processor; and
at least one memory storing instructions that, when executed by the at least one processor, cause the apparatus at least to:
determine that a first sidelink transport block, TB, among a plurality of sidelink TBs from another apparatus is not to be retransmitted, wherein a set of consecutive slots in a channel occupancy time, COT, initiated by the another apparatus are reserved for initial sidelink transmissions and retransmissions of the plurality of sidelink TBs; and
transmit a sidelink transmission in a slot among the set of consecutive slots reserved for retransmitting the first sidelink TB.

48. The apparatus of claim 47, wherein the apparatus is a terminal device.
